(19) United States
(12) Patent Application Publication
(10) Pub. No.: US 2025/0198271 A1
(43) Pub. Date: Jun. 19, 2025

(54) LUBRICATING OIL SEQUENCE VALVE HEATING SYSTEM

(71) Applicant: STEWART & STEVENSON LLC, Houston, TX (US)

(72) Inventor: Brian SHARP, Houston, TX (US)

(21) Appl. No.: 18/948,831

(22) Filed: Nov. 15, 2024

Related U.S. Application Data
(60) Provisional application No. 63/610,166, filed on Dec. 14, 2023.

(51) Int. Cl. E21B 43/26; F16K 21/04; G05D 7/06; G05D 23/19

(52) U.S. Cl. CPC E21B 43/2607; F16K 21/04; G05D 7/0617; G05D 23/19

(57) ABSTRACT

An apparatus includes a frac pump. The apparatus also includes a lubricating system, the lubricating system in fluid connection with the frac pump, the lubricating system including a lubricating oil tank and a lubricating oil pump in fluidic connection with the lubricating oil tank. The lubricating system also includes a directional valve, wherein the directional valve in fluidic connection to the lubricating oil pump and the frac pump and a sequence valve, the sequence valve in fluidic connection to the directional valve and the lubricating oil tank.

### CROSS-REFERENCE TO RELATED APPLICATIONS

This application is a nonprovisional application which claims priority from U.S. provisional application No. 63/610,166, filed Dec. 14, 2023, which is incorporated by reference herein in its entirety.

### TECHNICAL FIELD/FIELD OF THE DISCLOSURE

The present disclosure relates generally to a system for heating lubricating oil for a hydraulic pump using valves within a manifold

### BACKGROUND OF THE DISCLOSURE

In pumping equipment systems, lubrication (lube) oil is used to prolong the life of components which create friction with their movement of operation. Specifically, lube oil is used in pumps for hydraulic fracking (frac) operations. In some traditional systems, lube oil must be above a minimum temperature, for example, 70° F. to operate properly.

Traditionally, lube oil is heated to the minimum temperature using an electric heater within the frac pump system. Sensors within the system detect the temperature of the lube oil as it moves through the heater, filter, and pumps. Further, sequence valves are traditionally used in hydraulic systems to maintain a minimum pressure in a pump.

### SUMMARY

The present disclosure provides for an apparatus. The apparatus includes a frac pump. The apparatus also includes a lubricating system, the lubricating system in fluidic connection with the frac pump, the lubricating system including a lubricating oil tank and a lubricating oil pump in fluidic connection with the lubricating oil tank. The lubricating system also includes a directional valve, the directional valve in fluidic connection to the lubricating oil pump and the frac pump and a sequence valve, the sequence valve in fluidic connection to the directional valve and the lubricating oil tank.

The present disclosure also provides for a method. The method includes determining a temperature of a lubricating oil and pumping the lubricating oil from a lubricating oil tank to a directional valve. In addition, the method includes selecting a first position of a directional valve, allowing the lubricating oil to flow over a sequence valve to heat the lubricating oil and flowing the lubricating oil to the lubricating oil tank.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic diagram of a lubricating oil sequence valve heating system in conjunction with a frac pump consistent with certain embodiments of the present disclosure.

FIG. 2 is a schematic diagram of a lubricating oil sequence valve heating system consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

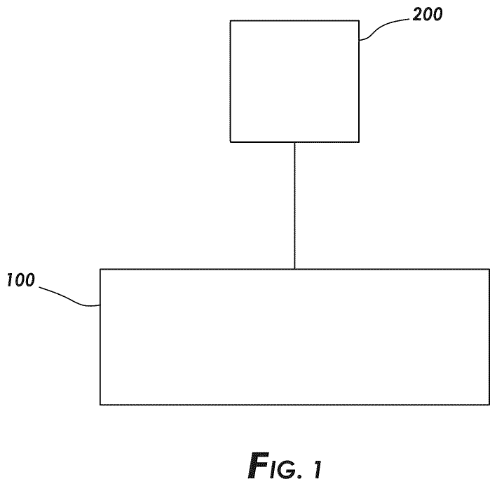

FIG. 1 depicts lubricating system 100 in conjunction with frac pump 200. Lubricating system 100 provides lubricating oil to frac pump 200 for cooling and otherwise lubricating.

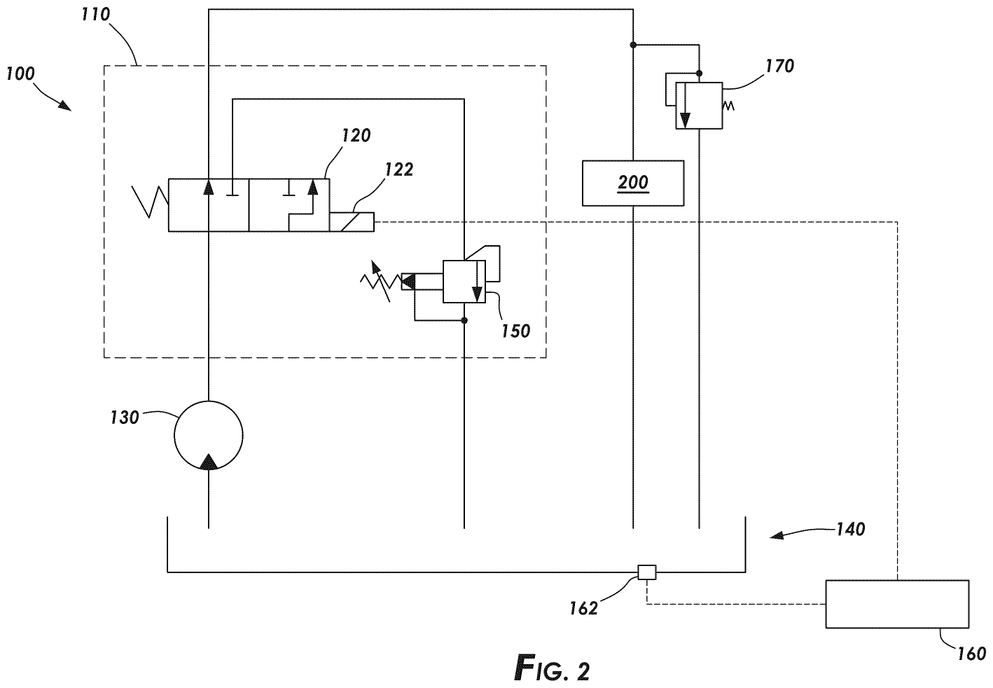

Sequence valve 150, as shown in FIG. 2 and described hereinbelow, creates backpressure on lubricating oil pump 130 to overcome the spring force of the sequence valve's 150 pressure holding spring, thereby opening the valve. In certain embodiments, the operating pressure of sequence valve 150 may be at least 400 psi.

During certain periods, lubricating oil may be warmed by passing the lubricating oil over sequence valve 150. With attention to FIG. 2, lubricating system 100 may include manifold 110. Manifold 110 may include directional valve 120 and sequence valve 150. Lubricating oil pump 130 may fluidically connect to lubricating oil tank 140 and to directional valve 120. Directional valve 120 may direct lubricating oil to sequence valve 150 or to frac pump 200. Thus, directional valve 120 controls the flow of the lubricating oil to either frac pump 200 or to sequence valve 150. In certain embodiments, directional valve 120 may be, for example, a two position four-way directional valve. Sequence valve 150 and frac pump 200 may both fluidically connect to lubricating oil tank 140.

In addition, lubricating system 100 may include controller 160. Controller 160 may be in electrical connection with temperature sensor 162. Temperature sensor 162 may be adapted to measure the temperature of the lubricating oil within lubricating system 100 and communicate the temperature measurement of the lubricating oil to controller 160. In certain embodiments, controller 160 and temperature sensor 162 form a temperature switch. Although shown as positioned to measure the temperature of the lubricating oil in lubricating oil tank 140, one of ordinary skill in the art with the benefit of this disclosure will recognize that temperature sensor 162 may be positioned anywhere within lubricating system 100 and multiple temperature sensors 162 may be provided. Controller 160 may also be in electrical connection with directional valve 120, specifically solenoid 122. Activation of solenoid 122 of directional valve 120 may cause directional valve 120 to switch from providing lubrication oil to sequence valve 150 to frac pump 200 or vice versa.

In certain embodiments, such as shown in FIG. 2, lubricating system 100 may also include relief valve 170 upstream of frac pump 200. Relief valve 170 may be in fluidic connection with lubricating oil tank 140 and frac pump 200.

During operation, temperature sensor 162 may determine the temperature of the lubricating oil within lubricating system 100. If below a preset temperature, directional valve 120 may direct the lubricating oil to be heated by running it over sequence valve 150 and then sent to lubricating oil tank 140. If above a preset temperature, directional valve 120 may direct the lubricating oil directly to lubricating oil tank 140. In other embodiments, directional valve 120 may be operated manually.

Sequence valve 150 heats the oil due to the drop in pressure as the hydraulic oil moves across sequence valve 150 wherein the energy produced by this drop is released as heat. In certain embodiments, sequence valve 150 may be set to a desired pressure. This pressure setting may be between 400 and 600 psi, for example and without limitation.

In certain embodiments, lubricating oil may be pre-treated with an anti-foam additive to reduce the surface tension of the lubricating oil. Such an action may prevent or retard formation of foam or air bubbling as the lubricating oil is flowed over sequence valve 150.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An apparatus comprising:
a frac pump;
a lubricating system, the lubricating system in fluid connection with the frac pump, the lubricating system including:
a lubricating oil tank;
a lubricating oil pump in fluidic connection with the lubricating oil tank;
a directional valve, the directional valve in fluidic connection to the lubricating oil pump and the frac pump; and
a sequence valve, the sequence valve in fluidic connection to the directional valve and the lubricating oil tank.

2. The apparatus of claim 1 further comprising a manifold, wherein the directional valve and the sequence valve are part of the manifold.

3. The apparatus of claim 1 further comprising:
a temperature sensor, the temperature sensor in direct or indirect fluidic connection with the lubricating oil tank;
a controller, the controller in electrical connection with the temperature sensor and the directional valve.

4. The apparatus of claim 3, wherein the temperature sensor and controller are combined into a temperature switch.

5. The apparatus of claim 1 further comprising a relief valve, the relief valve in fluidic connection with the lubricating oil tank and the frac pump.

6. The apparatus of claim 1, wherein the directional valve is a two position four way directional valve.

7. A method comprising:
determining a temperature of a lubricating oil;
pumping the lubricating oil from a lubricating oil tank to a directional valve;
selecting a first position of a directional valve if the temperature of the lubricating oil is above a preset temperature;
allowing the lubricating oil to flow over a sequence valve to heat the lubricating oil; and
flowing the lubricating oil to the lubricating oil tank.

8. The method of claim 7 further comprising before the step of determining the temperature:
pre-treating the lubricating oil with an anti-foam additive.
